(19) United States
(12) Patent Application Publication
(10) Pub. No.: US 2025/0131135 A1
(43) Pub. Date: Apr. 24, 2025

(54) DYNAMIC CONTROL OF TRACE PERMISSIONS IN OPERATING SYSTEMS VIA TRUSTED EXECUTION ENVIRONMENTS

(71) Applicant: Micron Technology, Inc., Boise, ID (US)

(72) Inventor: Zhan Liu, Cupertino, CA (US)

(21) Appl. No.: 18/788,751

(22) Filed: Jul. 30, 2024

Related U.S. Application Data
(60) Provisional application No. 63/591,845, filed on Oct. 20, 2023.

(51) Int. Cl. G06F 21/78; G06F 21/33; G06F 21/60

(52) U.S. Cl. CPC G06F 21/78; G06F 21/33; G06F 21/604

(57) ABSTRACT

In some implementations, the techniques described herein relate to a system including: an operating system; and a trusted execution environment including a controller and a write-protected storage area, wherein the controller is configured to: receive a command to modify access to trace functionality provided by the operating system, validate the command using a public key stored in the write-protected storage area, and update a register accessible by the operating system based on the command in response to validating the command, wherein the operating system is configured to allow or disallow access to trace functionality based on contents of the register.

### RELATED APPLICATIONS

The present application claims priority to Prov. U.S. Pat. App. Ser. No. 63/591,845 filed Oct. 20, 2023, the entire disclosure of which application is hereby incorporated herein by reference.

### FIELD OF THE TECHNOLOGY

At least some embodiments disclosed herein relate generally to the security of computing systems and, in particular, toward allowing and disallowing trace functionality using a trusted execution environment.

### BACKGROUND

Computer operating systems often possess trace functionalities, allowing for the monitoring and recording of system calls and user activities. These trace capabilities, used for diagnostics and debugging, are traditionally managed based on user privileges, with root users holding the power to access and manipulate them without restraints. Consequently, securing and controlling these functionalities becomes paramount, especially in environments where user data privacy and system integrity are critical.

### BRIEF DESCRIPTION OF THE DRAWINGS

FIG. 1 is a block diagram illustrating a secure computing system for allowing and disallowing trace functionalities according to some of the disclosed embodiments.

FIG. 2 is a flow diagram illustrating a method for validating a request to allow or disallow trace functionalities according to some of the disclosed embodiments.

FIG. 3 is a flow diagram illustrating performing a trace function according to some of the disclosed embodiments.

FIG. 4 is a flow diagram illustrating a method for delegating control of trace functionalities according to some of the disclosed embodiments.

FIG. 5 is a block diagram illustrating a computing system according to some of the disclosed embodiments.

FIG. 6 is a block diagram of a computing device according to some of the disclosed embodiments.

### DETAILED DESCRIPTION

The disclosure provides solution for trace functionality enablement via a system and method for securely managing access to tracing functionalities within computer operating systems. The system includes a trusted execution environment, which is a secure part of the device. This environment contains a special area where a public key is stored, preventing any alterations. One function of the trusted execution environment is to receive and assess commands that ask to either allow or disallow tracing. The assessment of these commands is done using the stored public key. If the command is validated, a register, or a specific kind of data storage within the device, is updated. This update then informs the operating system if tracing should be allowed or not. Some commands might also include details like a monotonic counter value or nonce value for extra validation. The system is equipped to manage different kinds of tracing functionalities, such as FTRACE, BPF, and others. The system also includes a delegation feature where the system can receive a special command to allow another entity to control the tracing for a set time, determined by the validity of an associated digital certificate. Additionally, the invention includes a storage medium that holds the computer instructions for these processes.

In some implementations, the techniques described herein relate to a system including: an operating system; and a trusted execution environment including a controller and a write-protected storage area, wherein the controller is configured to: receive a command to modify access to trace functionality provided by the operating system, validate the command using a public key stored in the write-protected storage area, and update a register accessible by the operating system based on the command in response to validating the command, wherein the operating system is configured to allow or disallow access to trace functionality based on contents of the register.

In some implementations, the techniques described herein relate to a system, wherein the command to modify access to trace functionality includes one of a command to allow access to trace functionality or a command to disallow access to trace functionality.

In some implementations, the techniques described herein relate to a system, wherein the public key is associated with a private key of a key management system.

In some implementations, the techniques described herein relate to a system, wherein validating the command further includes validating one of a monotonic counter value or nonce value included in the command.

In some implementations, the techniques described herein relate to a system, wherein the trace functionality includes one or more of access to ftrace, bpf, kprobes, or uprobes system calls.

In some implementations, the techniques described herein relate to a system, wherein updating a register includes updating one of a register or a subset of bits of the register.

In some implementations, the techniques described herein relate to a system, wherein the controller is further configured to: receive a second command to delegate trace control, the second command signed using a key management system private key and containing a second public key and a digital certificate associated with the second public key; validate the second command using the public key stored in the write-protected storage area; and delegate control of trace functionality to the second public key for a fixed duration, the fixed duration determined based on an expiration time of the digital certificate.

In some implementations, the techniques described herein relate to a method including: receiving, by a trusted execution environment, a command to modify access to trace functionality provided by an operating system; validating, by the trusted execution environment, the command using a public key stored in a write-protected storage area; and updating, by the trusted execution environment, a register accessible by the operating system based on the command in response to validating the command, wherein the operating system is configured to allow or disallow access to trace functionality based on contents of the register.

In some implementations, the techniques described herein relate to a method, wherein the command to modify access to trace functionality includes one of a command to allow access to trace functionality or a command to disallow access to trace functionality.

In some implementations, the techniques described herein relate to a method, wherein the public key is associated with a private key of a key management system.

In some implementations, the techniques described herein relate to a method, wherein validating the command further includes validating one of a monotonic counter value or nonce value included in the command.

In some implementations, the techniques described herein relate to a method, wherein the trace functionality includes one or more of access to ftrace, bpf, kprobes, or uprobes system calls.

In some implementations, the techniques described herein relate to a method, wherein updating a register includes updating one of a register or a subset of bits of the register.

In some implementations, the techniques described herein relate to a method, further including: receiving, by the trusted execution environment, a second command to delegate trace control, the second command signed using a key management system private key and containing a second public key and a digital certificate associated with the second public key; validating, by the trusted execution environment, the second command using the public key stored in the write-protected storage area; and delegating, by the trusted execution environment, control of trace functionality to the second public key for a fixed duration, the fixed duration determined based on an expiration time of the digital certificate.

In some implementations, the techniques described herein relate to a non-transitory computer-readable storage medium for tangibly storing computer program instructions capable of being executed by a computer processor, the computer program instructions defining steps of: receiving, by a trusted execution environment, a command to modify access to trace functionality provided by an operating system; validating, by the trusted execution environment, the command using a public key stored in a write-protected storage area; and updating, by the trusted execution environment, a register accessible by the operating system based on the command in response to validating the command, wherein the operating system is configured to allow or disallow access to trace functionality based on contents of the register.

In some implementations, the techniques described herein relate to a non-transitory computer-readable storage medium, wherein the command to modify access to trace functionality includes one of a command to allow access to trace functionality or a command to disallow access to trace functionality.

In some implementations, the techniques described herein relate to a non-transitory computer-readable storage medium, wherein the public key is associated with a private key of a key management system.

In some implementations, the techniques described herein relate to a non-transitory computer-readable storage medium, wherein validating the command further includes validating one of a monotonic counter value or nonce value included in the command.

In some implementations, the techniques described herein relate to a non-transitory computer-readable storage medium, wherein the trace functionality includes one or more of access to ftrace, bpf, kprobes, or uprobes system calls.

In some implementations, the techniques described herein relate to a non-transitory computer-readable storage medium, the steps further including: receiving, by the trusted execution environment, a second command to delegate trace control, the second command signed using a key management system private key and containing a second public key and a digital certificate associated with the second public key; validating, by the trusted execution environment, the second command using the public key stored in the write-protected storage area; and delegating, by the trusted execution environment, control of trace functionality to the second public key for a fixed duration, the fixed duration determined based on an expiration time of the digital certificate.

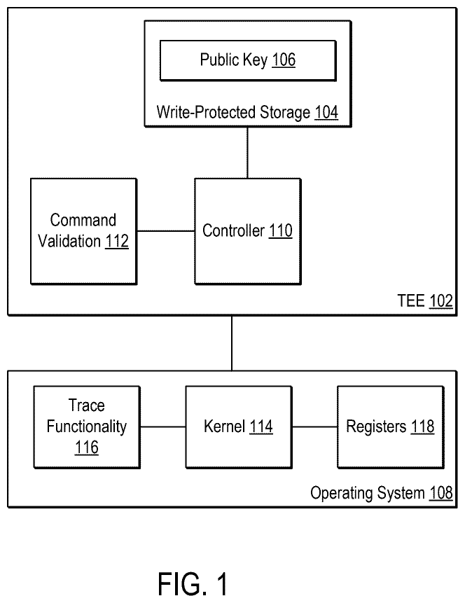

FIG. 1 is a block diagram illustrating a secure computing system for allowing and disallowing trace functionalities according to some of the disclosed embodiments.

As illustrated, in the system an operating system 108 is communicatively coupled to a trusted execution environment 102. As illustrated, operating system 108 can include a kernel 114 that accesses volatile data stored in registers 118. The operating system 108 includes trace functionality 116. In some implementations, trace functionality 116 can be separate from the kernel 114 or can be compiled into the kernel 114. A trusted execution environment 102 includes a controller 110 that receives data from operating system 108 and transmits data to operating system 108. Trusted execution environment 102 further includes a command validation module 112 that can validate signed commands received from operating system 108. Trusted execution environment 102 includes a write-protected storage area 104 that can store secured or sensitive data. As illustrated, write-protected storage area 104 can include cryptographic keys such as a public key 106. In some implementations, the public key 106 can comprise a public key of a key management system (not illustrated). In some implementations, the key management system can be a remote computing system for managing cryptographic keys.

As illustrated the system includes an operating system 108. In some implementations, the operating system 108 can comprise a general-purpose operating system. In some implementations, this general-purpose operating system can comprise a Linux operating system, Unix, operating system, Microsoft Windows operating system, macOS operating system, or any similar type of general-purpose operating system. Although general-purpose operating systems are described, the disclosure is not limited as such. Indeed, other operating systems that are not general-purpose may be used such as real-time operating systems, mobile operating systems, or similar types of operating systems. In general, and as illustrated in FIG. 1, the operating system can include a kernel 114. In general, a kernel can provide base functionalities for the operating system such as file input and output, network operations, logging, drivers, and various other functionalities required by the operating system and applications using the operating system.

As illustrated, the operating system 108 includes trace functionality 116. In some implementations, trace functionality 116 can be implemented separate from the kernel 114. Alternatively, trace functionality 116 can be compiled into the object code of the kernel 114. Trace functionality 116 may comprise programming logic or other code for tracing function calls, data, or other aspects of software used by the operating system. Examples of trace functionalities 116 include ftrace, bpf, kprobes, uprobes, User Statically-Defined Tracing (USDT) tracepoints, LTTng (Linux Trace Toolkit: next generation), perf event, and similar system libraries or modules. As discussed, these trace functionalities may be compiled into the kernel before it is executed by the device. In current systems, the decision on whether to include and enable or disable trace functionality thus must be made at the time of compilation and cannot be changed once the kernel 114 and operating system 108 are compiled and deployed. In some current systems, user access permissions are used by the kernel 114 to determine whether to allow or disallow trace functionality. However, such approaches are limited and potentially less secure given that the trace functionality would be an enabled at all times and is subject to software control only by the kernel 114. As will be discussed throughout, the disclosed embodiments provide an alternative improved solution for managing access to trace functionality.

Operating system 108 further includes registers 118. The specific number of registers in registers 118 is not limited. In general, registers 118 may be implemented as a register file by the underlying device and managed by assembly or similar code in the kernel 114. As will be discussed one or more of these registers can be used as flags to enable or disable some or all the trace functionality 116. Although illustrated as part of the operating system 108, the underlying hardware implementing registers 118 may be stored elsewhere. For example, registers 118 may be physically stored within trusted execution environment 102.

Trusted execution environment 102 comprises a secure computing environment that is tamper proof and provides secure computing and storage functionalities to the device. Various types of technologies can be used to implement trusted execution environment 102 building but not limited to secure enclaves, hardware security modules, etc. The specific choice of underlying trusted execution environment technology is not limiting, and any secure computing technology can be used.

As illustrated the trusted execution environment 102 includes a controller 110. Controller 110 may comprise a general-purpose processing unit such as a central processing unit or similar type of processor. In some implementations, controller 110 can perform a variety of functions for operating the trusted execution environment 102. For example, the trusted execution environment 102 may have an interface to communicatively couple it to the operating system 108. In some implementations, controller 110 can receive commands from the operating system 108 via this interface. In some implementations, these commands can comprise signed commands. In some implementations, a signed command comprises a command for the trusted execution environment 102 that includes a digital signature. In some implementations, this digital signature is constructed by using the unsigned command as an input to a digital signature algorithm and using a private key to generate the digital signature. In some implementations, the private key used can comprise a private key stored remotely by a key management system (not illustrated).

As illustrated, trusted execution environment 102 includes a write-protected storage area 104. In some implementations, write-protected storage area 104 can comprise a non-volatile storage location accessible only by the controller 110. In some implementations, write-protected storage area 104 is physically secured within the trusted execution environment from access by any other device. Further, in some implementations, write-protected storage area 104 can comprise a subset of a larger storage device whereby controller 110 enforces write protection on the subset of memory locations.

In some implementations, write-protected storage area 104 can store cryptographic data. In some implementations, this cryptographic data can include a public key 106. In some implementations, this public key 106 can include a public key corresponding to a private key maintained by a remote key management system. The specific type of cryptographic key is not limiting. In some implementations, an Elliptic Curve Digital Signature Algorithm (ECDSA) key may be used. In other implementations, a Rivest-Shamir-Adleman (RSA) key can be used. Certainly, other asymmetric key algorithms may be used to generate the public and thus private keys. In some implementations, a key management system public key can be written to the write-protected storage area 104 during manufacturing of the device depicted in FIG. 1.

Although one key is illustrated in FIG. 1, the specific number of keys stored in write-protected storage area 104 is not limited. Indeed, write-protected storage area 104 may store many keys including both public keys and private keys. As will be discussed later, write-protected storage area 104 you can store both a remote key management system public key as well as one or more separate owner public keys.

Returning to controller 110, upon receipt of a signed secure command via the interface with the operating system 108 the controller 110 can pass the command as well as public key to the command validation module. The command validation module can validate this signed command by validating the digital signature using the public key 106. The specific details of how to validate a digital signature using a public key are not described herein for the sake of clarity and any existing digital signature validation algorithm can be used. For example, RSA Digital Signature Algorithm (DSA), ECDSA, Edwards-Curve Digital Signature Algorithm (EdDSA), and similar algorithms may be used. Once the command validation module 112 validates the signed command it returns a success result to the controller 110 which may then execute the command. In some implementations, the signed command can further include additional data used to validate the command. For example, a monotonic counter value or nonce value can also be included to prevent replay attacks as well as generally improve the security of the command.

In some implementations, the unsigned command can be provided to a key management system for signing. In some implementations, the key management system can implement authorization and authentication logic to ensure that only device owners are able to access the system and receive signed commands. In this manner the device need not authenticate users individually via credentials and can rely on a validly signed command being authentic. For example, an owner of the device may submit a command to the key management system after authenticating and receive the signed command. The receiving device can then transmit the signed command to the trusted execution environment 102 for processing. In some implementations, the command can also include the specific trace functionality needed. For example, a command can specify one or more trace functionalities, such as FTRACE that are being allowed or disallowed.

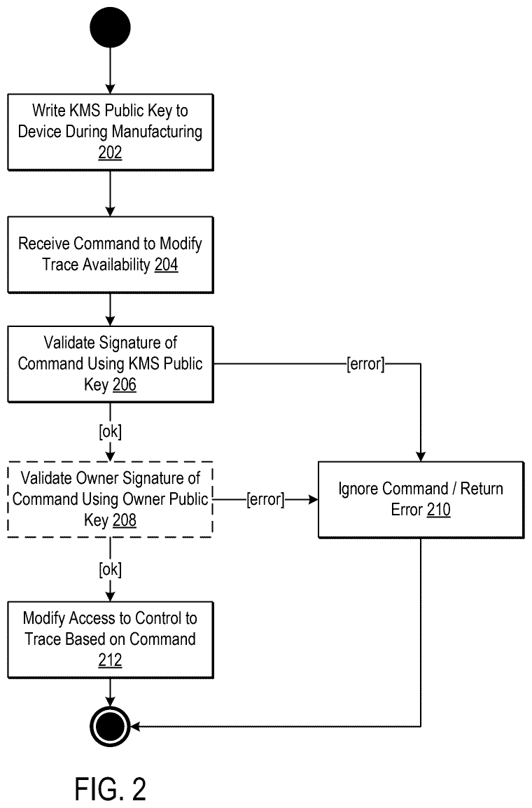

As will be discussed in connection with the following FIGS. 2 through 4 various types of commands related to trace functionality 116 may be processed by trusted execution environment 102. One such command is a command to allow or disallow trace functionality 116 by the operating system 108. Another such command is one to delegate control of trace functionality 116 to a different owner (e.g., a different public key). As will be discussed in further detail, the use of public key cryptography ensures that only a trusted entity or owner of the device can control access to trace functionality 116. As will be discussed, this control may be implemented by the trusted execution environment 102 updating a register value within registers 118 securely based on processing a secure command. The kernel 114 can then rely on the register value in registers 118 when determining whether to allow or disallow access to trace functionality 116. In this manner, trace functionality 116 can be compiled into kernel 114 as part of operating system 108 and the registers 118 can be used by the kernel (or operating system) to selectively and dynamically enable and disable access to trace functionality 116. In this regard, the disclosed embodiments can be utilized with any existing operating system regardless of how trace functionality is included within the operating system 108. The following FIGS. 2 through 4 describe the functional operations of the system illustrated in FIG. 1 and those details are incorporated in the description of FIG. 1 in their entirety.

As discussed in current systems if a root user is compromised, access to trace functionality is unimpeded and presents a security risk. By contrast, in the alternative or in conjunction with user access permissions, the disclosed embodiments utilize public key cryptography to ensure that the actual owner of the device is the only one that can enable or disable trace functionality thus increasing the security of the system.

FIG. 2 is a flow diagram illustrating a method for validating a request to allow or disallow trace functionalities according to some of the disclosed embodiments.

In step 202, the method can include writing a key management system public key to a device during manufacturing.

In some implementations, when a device such as a storage device or a computing device is manufactured, the manufacturer can write a public key to a write-protected storage area of the device. In some implementations, this public key can comprise any type of public key such as an ECDSA public key or RSA public key although the specific type of key technology is not limiting. In some implementations, during manufacturing, the corresponding private key can be stored in a centralized key management system. As discussed, this key management system can handle authentication and authorization of key owners and can handle transfers of ownership of devices by changing public keys. Specific details of a key management system are not described in detail here and for the sake of brevity. Although the operation of generating a signed command is described herein. As discussed in FIG. 1, by writing the key management system public key to an area that cannot be tampered with, the method can ensure that the device including the trusted execution environment will always have access to a valid public key of the key management system. Thus, the trusted execution environment can ensure that the key management system can sign and issue commands in a trusted manner.

In step 204, the method can include receiving a command to modify trace availability (e.g., allowed or disallowed).

In some implementations, an operating system can issue the command to modify trace availability to the trusted execution environment. In some implementations, the operating system can generate the command by requesting such a command from the key management system. In some implementations, the operating system can transmit a network request to the key management system requesting the command. In response, the key management system can validate the user request or the user and consign the command and return the signed command or, alternatively, the digital signature to include with the command.

In some implementations, the command can comprise a command to allow access to trace functionalities or a command to disallow access to trace functionalities. The specific format of the command is not limiting and may be designed based on the underlying trusted execution environment command set. In some implementations, the command can include a set of one or more trace functionalities to allow or disallow. For example, the set can include identifiers of specific trace functionalities implemented as system calls by the kernel of the operating system such as FTRACE etc. In this manner the command can specify a limited subset of trace functionalities to reduce an attack surface. Certainly, in some implementations, the command can forgo an identification of specific trace functionalities and simply be associated with all trace functionalities. In such a scenario, the command would enable or disable all trace functionalities in a single invocation. And some of invitations, the command can include further flags to control access to the trace functionalities. For example, these flags may indicate iteration and identification of a user or group or other types of parameters to control who has access to trace functionalities and when that access is allowed.

In step 206, the method can include validating a signature of the command received in step 204 using the key management system public key.

In response to receiving a signed command to modify access to trace functionalities, the trusted execution environment first validates the digital signature included in the command. Specific digital signature validation algorithms are not described in detail herein and any known digital signature algorithm can be used.

In some implementations, the method can include reading a public key from a write protected storage area of the trusted execution environment. In one implementation, this public key corresponds to a private key held by the key management system. In some of them take implementations, the key management system stores a private key for an owner of the device. As discussed, the corresponding public key is written to the device during manufacturing. As such, only the authorized owner of the device can generate a valid digital signature. Thus, in step 206, the method can include confirming that the issuer of the signed command is the owner of the device. In some implementations, the command can include a monotonic counter value or a nonce value that is either generated by the key management system or by the operating system itself. These can be used to ensure freshness of the command and prevent replay attacks in similar types of security issues.

If the signature validation of step 206 fails, the method proceeds to step 210 where it can ignore the command and optionally return an error.

As discussed, the signature validation will fail if someone other than the owner of the public key stored in the trusted execution environment signs the command. Further validation can also fail if one or more of the values in the command are not the expected values. For example, if the value of a monotonic counter or of a nonce value are incorrect, then the validation will fail.

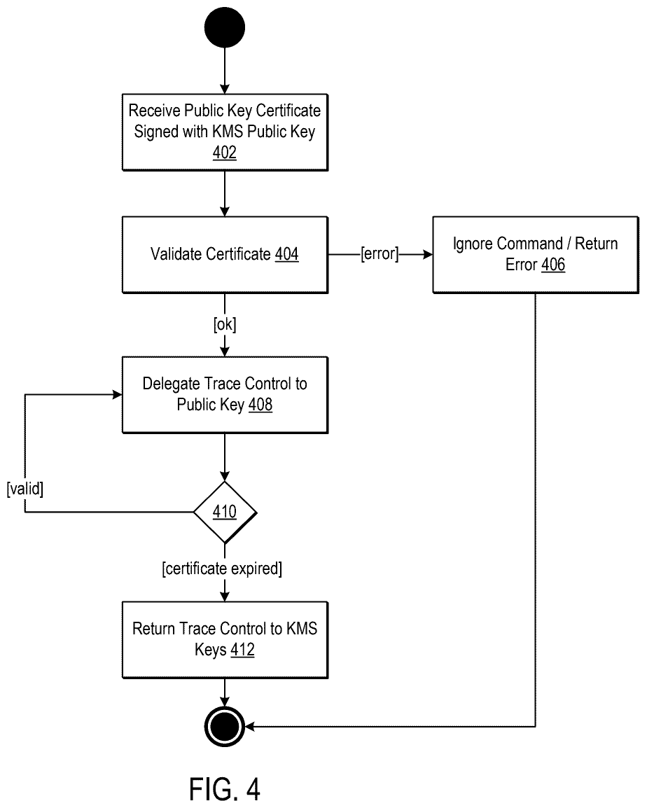

If the signature validation of step 206 succeeds, the method proceeds to step 208 where the method can include optionally validating an owner signature of the command using a separate owner public key. In some implementations, the trusted execution environment can store multiple public keys. As discussed in step 204 and step 206, one such public key can be the key management system public key. However, the trusted execution environment can also store alternative public keys such as an owner public key or a trusted user public key. In some of implementations, the key management system can sign a command to write these public keys to the trusted execution environment in a manner similar to what was described previously. In this manner there can be multiple “owners” of the device that are allowed to enable or disable trace functionality. In this scenario, the method can read a second digital signature and a second public key can be used to validate the second digital signature. In alternative implementations, the trusted execution environment may utilize one of these second public keys instead of the key management system public key. Further details on this operation are described with respect to a delegation procedure described and FIG. 4.

In step 212, the method can include modifying access controls to trace functionality according to the command.

If the trusted execution environment validates the signed command to modify access to trace functionality, it will take steps to propagate this change to the operating system. In some implementations, the trusted execution environment can transmit a command to the operating system to update a register or a bit of a register accessible by the operating system.

For example, the operating system may access a register file of one or more registers. In some implementations, one of these registers can include a fixed number of bits that can be set or unset to enable or disable, respectively, trace functionalities. As a simplified example, a 32-bit register can be used to enable or disable trace functionalities for thirty-two trace functionalities. Certainly, the number of available trace functions in an operating system may be less than thirty-two and the use of thirty-two bits is provided only as an example. In such a scenario, some bits may be unused.

As an example, if an operating system has four trace functionalities one of which is an FTRACE functionality the system may use a zero-bit position to correspond to the FTRACE functionality. In this scenario, the trusted execution environment would issue a command for the operating system to write a value of one (“0B0001”) to the register which would result in bit zero being set to one and all other bits being set to zero.

As will be discussed the operating system can read this register value and use the bit values to determine whether or not to allow or disallow a system call to the corresponding trace functionality. As an alternative implementation, instead of using a single register and using bits to signal enabling or disabling access to trace functionalities the system may use multiple registers with each register being associated with a trace functionality. Such an approach increases the use of registers but allows for additional information to be stored in a given register for each trace functionality. This may be useful if additional detail for each individual trace functionality is required. For example, if the system would like to store a list of users or a list of groups that should be given access to a trace functionality, more information beyond one bit may be needed to convey that information and thus an entire register may be useful for conveying that information from the trusted execution environment to the operating system.

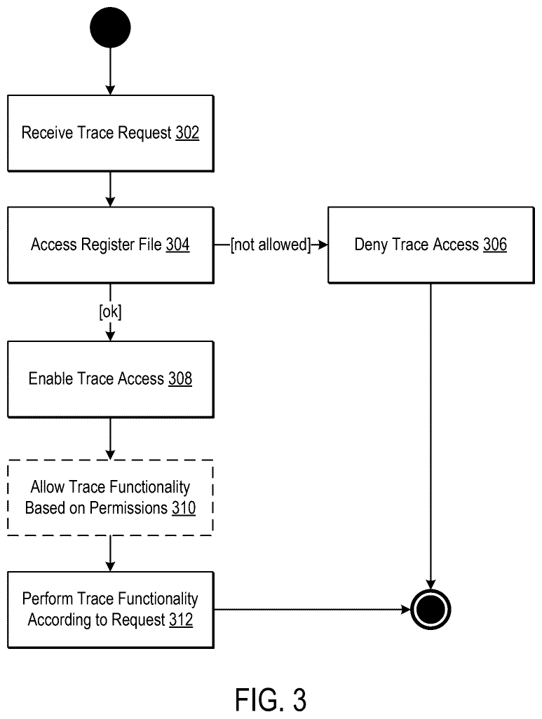

FIG. 3 is a flow diagram illustrating performing a trace function according to some of the disclosed embodiments.

In step 302, the method can include receiving a trace request.

In some implementations, an operating system or a kernel can receive a trace request. In some implementations, trace requests can take the form of system calls to one or more trace functionalities provided by the operating system and/or kernel. In some implementations, the trace requests can be issued as part of command line invocations of trace functionalities. In other implementations, the trace request can be issued as embedded code calling trace functionalities within compiled binary code. In some implementations, the operating system can be modified to intercept calls to these system calls for providing trace functionalities and handle them according to the methods described herein.

In step 304, the method can include accessing a register file and determining based on its contents whether trace functionality is allowed.

In this step, the operating system or kernel reads a designated register in response to receiving a trace request. In implementations where a single register is used, step 304 can include reading the value of this register. In other implementations where multiple registers are used, with each register corresponding to a given trace functionality, the operating system or kernel can determine which register to read based on the system call of the trace functionality. In either scenario, for any given trace request, the method can load a register value defining the access permissions for the trace functionality. In some implementations, preexisting registers can be reused thus not requiring modification of the operating system or kernel.

In step 306, if the value read from the register file indicates trace functionality is not allowed, the method can include denying access to trace functionality.

In some implementations, the value read from the register file will ultimately be a single bit one or zero for a given trace functionality. For example, when a single register is used, and each bit corresponds to a trace functionality the method will include identifying the bit corresponding to the trace functionality and determining if it is one or zero. In some implementations, a value of one indicates that the trace functionality is allowed while a value of zero may indicate that that trace functionality is not allowed.

In other implementations, when an entire register is associated with the trace functionality the method may analyze the contents of the register to determine if and how to allow access to the trace functionality. For example, the register can include at least one bit that indicates whether trace functionality is allowed or disallowed, similar to the previous example. However, in this example, the register may include other bits that provide finer grained control over who has access to the trace functionality, how long the access is granted, or any other limitations on the trace functionality based on the underlying system call. For example, a certain subset of the bits may define the group number, user number, or other file system properties of users configured to have access to the trace functionality. As another example, a certain number of bits may indicate the amount of time in which access is given to the trace functionality expressed as a multiple of a unit of time.

In either of the above scenarios, the operating system will make the decision based on the register value about whether to allow the received trace request or disallow the received trace request. If upon reading the register value, the operating system determines that trace functionality is not allowed for the given circumstances the operating system will ignore the trace request and optionally return an error. As an example, if a trace request is received as an instruction within a binary application the operating system can treat that system call as a no-op value, thus effectively ignoring the trace request. Alternatively, the operating system can raise an exception upon determining that the included trace request or system calls is not allowed.

In step 308, if the value read from the register file indicates trace functionality is allowed, the method can include enabling access to trace functionality.

In contrast, if the operating system in step 304 determines that trace functionality access is allowed the method will proceed to allow the requested trace functionality. For example, if the trace request was made as part of a system call in a binary the method can perform the system call as requested. In some implementations, allowing access to a trace functionality may involve simply performing the requested trace functionality. In this manner, the specific details of performing a trace operation are not described in detail and may vary depending on the underlying operating system trace system call. In some implementations, however the operating system may adjust the operation of the trace functionality based on the value of the register. For example, in alternative implementations, the command to allow or disallow trace functionalities may include flags indicating how the trace functionality can be modified. For example, such flags may set a logging level or other type of output formatting step that can be used to modify the trace function regardless of how it is included by the user. For example, if a trace functionality includes multiple logging levels having multiple levels of detail when setting the register file via the secure commands the secure command can specify a default logging level that cannot be changed. Thus, the register value set via the secure command could not only be used to allow or disallow complete access to trace functionality but can also be used to manipulate the underlying system call before it's issued.

In step 310, the method can optionally include further allowing or disallowing trace functionality based on permissions associated with the requesting user.

In some implementations, the method can include determining next if the specific user has access to trace functionality. In some implementations, this can involve reading the user privileges to make a determination on whether the user is allowed to access trace functionalities. In some implementations, this step can comprise the traditional permissions-based control system for allowing access to trace functionalities. As such, the disclosed embodiments can further incorporate existing user permission models for providing multiple layers of access control to trace functionalities.

In step 312, the method can include performing the requested trace functionality according to the request.

As discussed after the trace request is allowed and all permissions are validated the system can then issue the system call to perform the trace request. Specific details of executing the trace function system call as part of an operating system or not described here in for the sake of clarity. Any existing or to be known trace functions may be executed in this step. As discussed in some embodiments the operating system may rewrite portions of the trace functionality system call based on the register value if necessary.

FIG. 4 is a flow diagram illustrating a method for delegating control of trace functionalities according to some of the disclosed embodiments.

In step 402, the method can include receiving a signed command signed with the key management system private key that includes a public key certificate that includes a new public key.

Details of signing a secure command have been provided previously in the description of FIG. 2 and are not repeated herein. In step 402, the specific signed command includes a payload that includes a digital certificate associated with a new public key. In some implementations, this can be implemented by including the certificate which includes the new public key within a specified command supported by the trusted execution environment. Similar to the command issued in FIG. 2, the command that includes the digital certificate is also signed by the key management system which holds the private key corresponding to the public key stored in the trusted execution environment's write-protected storage area. In some implementations, the key management system may validate the digital certificate prior to signing the command.

In step 404, the method can include validating the digital certificate.

Upon receiving the command that includes a digital certificate, the trusted execution environment can confirm that the digital certificate is valid using the key management system public key stored in the write-protected storage area. Specifically, in this step the trusted execution environment validates the command using the key management system public key similar to that described in FIG. 2. Further, and some implementations, step 404 can also include validating the digital certificate itself. In some implementations the key management system public key can also be used to validate the digital certificates, although other certificate authorities or other entities can be used for certificate validation. The specific details of validating a digital certificate using a public key are not described here and for the sake of clarity. Any existing, or to be known technique, for validating a digital certificate may be used. In effect, as part of step 404, the method can confirm that the current owner of the device has requested the trusted execution environment update or replace a public key with the public key included in the digital certificate.

In step 406, if the validation in step 404 fails, the method can include ignoring the command received in step 402. In some implementations, step 406 can also include returning an error code or response. As discussed in previous Figures, if the digital certificate validation fails, the trusted execution environment cannot confirm that the request to replace or update the public key is valid and will thus ignore the command. And some optional implementations, the trusted execution environment can further return an error code or message indicating the failure.

In step 408, if the validation in step 404 succeeds, the method can include delegating trace control to the public key associated with certificate received in step 402.

By contrast, if the trusted execution environment can validate the command and the digital certificate, the trusted execution environment can proceed to delegate authority to allow or disallow access to trace functionality based on the new public key included in the digital certificate. In one implementation, delegating trace control can comprise overriding the key management system public key. In this manner, the method of FIG. 2 can be executed by the new owner associated with the new public key. However, such an approach can potentially negatively impact other parts of the trusted execution environment because the key management system may no longer have access to the ability to sign commands using its own private key.

Thus, in other implementations, the trusted execution environment can delegate trace control to the new public key by writing the new public key to a second area of the write-protected storage area. The trusted execution environment will then utilize the new public key when executing the method of FIG. 2 instead of or in addition to using the key management system public key. Further, in some implementations, the trusted execution environment can store the digital certificate in the write-protected storage area for later use.

In step 410, the method can include determining if the delegation of trace control is still valid. If so, the method can include maintaining the delegation of trace control in step 408. If not, the method can proceed to step 412.

In some implementations, the trusted execution environment can use a fixed time period in which to allow or disallow delegation of trace control period. In other implementations, the trusted execution environment can utilize a time period specified in the digital certificate in which to allow delegation of trace control period. In some implementations, the trusted execution environment can utilize an expiration date of the digital certificate to use as a timer for determining how long to enable trace control delegation to the new public key. A trusted execution environment can store this duration in a secure location and as part of step 410 can continuously confirm that the timer is still valid. While the certificate has not expired, for example, the trusted execution environment continues to operate in step 408 where it delegates trace control to the new public key received in step 402 via the digital certificate. As discussed, this may include operating the method of FIG. 2 using this new public key. Ultimately the timer will expire in step 410, for example, when the digital certificate expires, and the method will proceed to step 412.

In step 412, after the method determines that the delegation of trace control has expired, the method can include returning trace control to the key management system keys (as discussed in FIG. 2).

In step 412, trusted execution environment will stop allowing the new public key to allow or disallow access to trace functionalities. In the first implementation discussed above, this may include removing the new public key from the write-protected storage area and replacing it with the key management system public key period. As discussed, such an implementation may potentially remove ownership of the device from the key management system public key. However, the trusted execution environment may store the key management system public key in a temporary storage area while the new ownership has been transferred and thus may move the key management system public key back to its original position effectively allowing the key management system to control the process of FIG. 2. In other implementations, where multiple public keys are stored in the trusted execution environment, the trusted execution environment may simply delete the new public key and revert to using the key management system public key and the operations of FIG. 2. In this manner, the method can temporarily allow a new public key access to allow or disallow trace functionalities in a device by utilizing a temporary change of public key. In some implementations, the system can ensure that by default the trusted execution environment will return to using the key management system public key. Further, in some implementations of step 412, the method can include resetting the registers set during the operation of FIG. 2 while delegating trace control and period in essence this operates to perform a “restore” of trace control functionality, thus ensuring that the system can return to a pristine state upon the expiration of a delegation of control.

In the foregoing embodiments, a system is described that allows for finer grain control of trace functionality without requiring modification of the kernel or operating system. Public key cryptography is used to validate an owner of a device to provide stronger authentication as compared to existing role-based privileges used in operating systems. Thus, as an example, if a root account of an operating system is compromised, trace functionality will only be exposed to the extent that the owner of the device has allowed trace functionality. In some implementations, the operating system and or kernel may allow for a remote operation by the operator to issue a signed command to the trusted execution environment to disallow all trace functionality. Thus, even if a root account was compromised the owner of the device upon learning of the compromise can remotely issue a command to completely disallow trace functionality on the device without requiring explicit input by the root user which was compromised. As such the disclosed embodiments provide an improved security operation involving trace functionality as compared to existing solutions in the art.

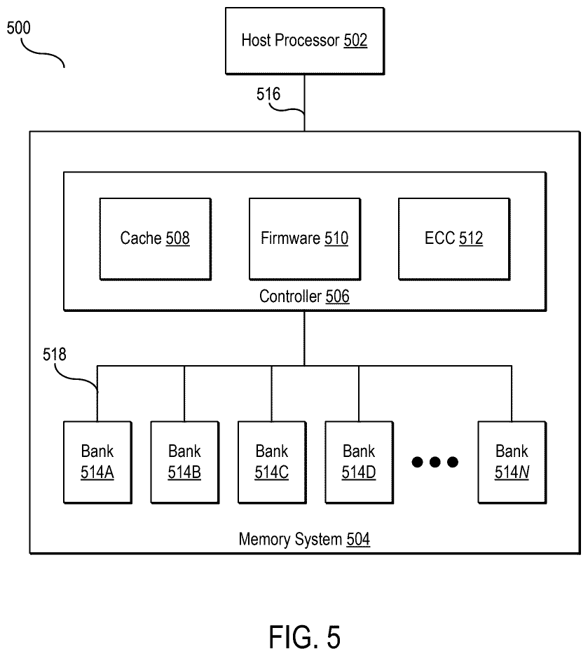

FIG. 5 is a block diagram illustrating a computing system according to some of the disclosed embodiments.

As illustrated in FIG. 5, a computing system 500 includes a host processor 502 communicatively coupled to a memory system 504 via a bus 516. The memory system 504 comprises a controller 506 communicatively coupled to one or more memory banks (e.g., bank 514A, bank 514B, bank 514C, bank 514D, bank 514N, etc.) forming a memory array via an interface 518. As illustrated, the controller 506 include a local cache 508, firmware 510, and an ECC 512.

In the illustrated embodiment, host processor 502 can comprise any type of computer processor, such as a central processing unit (CPU), graphics processing unit (GPU), or other types of general-purpose or special-purpose computing devices. The host processor 502 includes one or more output ports that allow for the transmission of address, user, and control data between the host processor 502 and the memory system 504. In the illustrated embodiment, this communication is performed over the bus 516. In one embodiment, the bus 516 comprises an input/output (I/O) bus or a similar type of bus.

The memory system 504 is responsible for managing one or more memory banks. In one embodiment, the memory banks comprise NAND Flash dies or other configurations of non-volatile memory. In one embodiment, the memory banks comprise a memory array.

The memory banks are managed by the controller 506. In some embodiments, the controller 506 comprises a computing device configured to mediate access to and from banks. In one embodiment, the controller 506 comprises an ASIC or other circuitry installed on a printed circuit board housing the memory banks. In some embodiments, the controller 506 may be physically separate from the memory banks. The controller 506 communicates with the memory banks over the interface 518. In some embodiments, this interface 518 comprises a physically wired (e.g., traced) interface. In other embodiments, the interface 518 comprises a standard bus for communicating with memory banks.

The controller 506 comprises various modules including local cache 508, firmware 510 and ECC 512. In one embodiment, the various modules (e.g., local cache 508, firmware 510 and ECC 512) comprise various physically distinct modules or circuits. In other embodiments, the modules (e.g., local cache 508, firmware 510 and ECC 512) may completely (or partially) be implemented in software or firmware.

As illustrated, firmware 510 comprises the core of the controller and manages all operations of the controller 506. The firmware 510 may implement some or all of the methods described above. Specifically, the firmware 510 may implement the methods described in the foregoing figures.

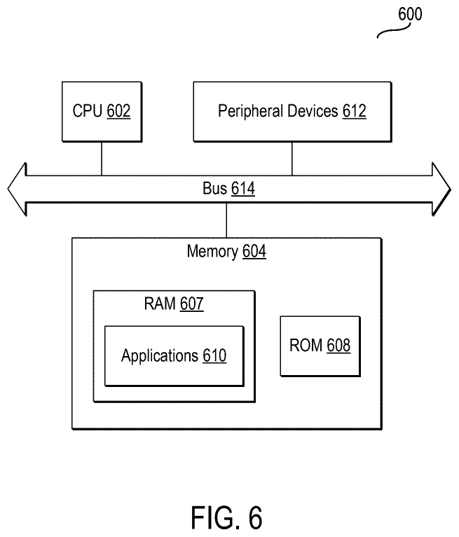

FIG. 6 is a block diagram of a computing device according to some of the disclosed embodiments.

As illustrated, the device 600 includes a processor or central processing unit (CPU) such as CPU 602 in communication with a memory 604 via a bus 614. The device also includes one or more input/output (I/O) or peripheral devices 612. Examples of peripheral devices include, but are not limited to, network interfaces, audio interfaces, display devices, keypads, mice, keyboard, touch screens, illuminators, haptic interfaces, global positioning system (GPS) receivers, cameras, or other optical, thermal, or electromagnetic sensors.

In some embodiments, the CPU 602 may comprise a general-purpose CPU. The CPU 602 may comprise a single-core or multiple-core CPU. The CPU 602 may comprise a system-on-a-chip (SoC) or a similar embedded system. In some embodiments, a graphics processing unit (GPU) may be used in place of, or in combination with, a CPU 602. Memory 604 may comprise a memory system including a dynamic random-access memory (DRAM), static random-access memory (SRAM), Flash (e.g., NAND Flash), or combinations thereof. In one embodiment, the bus 614 may comprise a Peripheral Component Interconnect Express (PCIe) bus. In some embodiments, the bus 614 may comprise multiple busses instead of a single bus.

Memory 604 illustrates an example of a non-transitory computer storage media for the storage of information such as computer-readable instructions, data structures, program modules, or other data. Memory 604 can store a basic input/output system (BIOS) in read-only memory (ROM), such as ROM 608 for controlling the low-level operation of the device. The memory can also store an operating system in random-access memory (RAM) for controlling the operation of the device.

Applications 610 may include computer-executable instructions which, when executed by the device, perform any of the methods (or portions of the methods) described previously in the description of the preceding figures. In some embodiments, the software or programs implementing the method embodiments can be read from a hard disk drive (not illustrated) and temporarily stored in RAM 607 by CPU 602. CPU 602 may then read the software or data from RAM 607, process them, and store them in RAM 607 again.

The device may optionally communicate with a base station (not shown) or directly with another computing device. One or more network interfaces in peripheral devices 612 are sometimes referred to as a transceiver, transceiving device, or network interface card (NIC).

An audio interface in peripheral devices 612 produces and receives audio signals such as the sound of a human voice. For example, an audio interface may be coupled to a speaker and microphone (not shown) to enable telecommunication with others or generate an audio acknowledgment for some action. Displays in peripheral devices 612 may comprise liquid crystal display (LCD), gas plasma, light-emitting diode (LED), or any other type of display device used with a computing device. A display may also include a touch-sensitive screen arranged to receive input from an object such as a stylus or a digit from a human hand.

A keypad in peripheral devices 612 may comprise any input device arranged to receive input from a user. An illuminator in peripheral devices 612 may provide a status indication or provide light. The device can also comprise an input/output interface in peripheral devices 612 for communication with external devices, using communication technologies, such as USB, infrared, Bluetooth®, or the like. A haptic interface in peripheral devices 612 provides tactile feedback to a user of the client device.

A GPS receiver in peripheral devices 612 can determine the physical coordinates of the device on the surface of the Earth, which typically outputs a location as latitude and longitude values. A GPS receiver can also employ other geo-positioning mechanisms, including, but not limited to, triangulation, assisted GPS (AGPS), E-OTD, CI, SAI, ETA, BSS, or the like, to further determine the physical location of the device on the surface of the Earth. In one embodiment, however, the device may communicate through other components, providing other information that may be employed to determine the physical location of the device, including, for example, a media access control (MAC) address, Internet Protocol (IP) address, or the like.

The device may include more or fewer components than those shown in FIG. 6, depending on the deployment or usage of the device. For example, a server computing device, such as a rack-mounted server, may not include audio interfaces, displays, keypads, illuminators, haptic interfaces, Global Positioning System (GPS) receivers, or cameras/sensors. Some devices may include additional components not shown, such as graphics processing unit (GPU) devices, cryptographic co-processors, artificial intelligence (AI) accelerators, or other peripheral devices.

The subject matter disclosed above may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware, or any combination thereof (other than software per se). The preceding detailed description is, therefore, not intended to be taken in a limiting sense.

Throughout the specification and claims, terms may have nuanced meanings suggested or implied in context beyond an explicitly stated meaning. Likewise, the phrase “in an embodiment” as used herein does not necessarily refer to the same embodiment and the phrase “in another embodiment” as used herein does not necessarily refer to a different embodiment. It is intended, for example, that claimed subject matter include combinations of example embodiments in whole or in part.

In general, terminology may be understood at least in part from usage in context. For example, terms, such as “and,” “or,” or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures, or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

The present disclosure is described with reference to block diagrams and operational illustrations of methods and devices. It is understood that each block of the block diagrams or operational illustrations, and combinations of blocks in the block diagrams or operational illustrations, can be implemented by means of analog or digital hardware and computer program instructions. These computer program instructions can be provided to a processor of a general-purpose computer to alter its function as detailed herein, a special purpose computer, application-specific integrated circuit (ASIC), or other programmable data processing apparatus, such that the instructions, which execute via the processor of the computer or other programmable data processing apparatus, implement the functions/acts specified in the block diagrams or operational block or blocks. In some alternate implementations, the functions or acts noted in the blocks can occur out of the order noted in the operational illustrations. For example, two blocks shown in succession can in fact be executed substantially concurrently or the blocks can sometimes be executed in the reverse order, depending upon the functionality or acts involved.

These computer program instructions can be provided to a processor of a general-purpose computer to alter its function to a special purpose; a special purpose computer; ASIC; or other programmable digital data processing apparatus, such that the instructions, which execute via the processor of the computer or other programmable data processing apparatus, implement the functions or acts specified in the block diagrams or operational block or blocks, thereby transforming their functionality in accordance with embodiments herein.

For the purposes of this disclosure a computer readable medium (or computer-readable storage medium) stores computer data, which data can include computer program code or instructions that are executable by a computer, in machine readable form. By way of example, and not limitation, a computer readable medium may comprise computer readable storage media, for tangible or fixed storage of data, or communication media for transient interpretation of code-containing signals. Computer readable storage media, as used herein, refers to physical or tangible storage (as opposed to signals) and includes without limitation volatile and non-volatile, removable, and non-removable media implemented in any method or technology for the tangible storage of information such as computer-readable instructions, data structures, program modules or other data. Computer readable storage media includes, but is not limited to, RAM, ROM, EPROM, EEPROM, flash memory or other solid-state memory technology, CD-ROM, DVD, or other optical storage, magnetic cassettes, magnetic tape, magnetic disk storage or other magnetic storage devices, or any other physical or material medium which can be used to tangibly store the desired information or data or instructions and which can be accessed by a computer or processor.

For the purposes of this disclosure a module is a software, hardware, or firmware (or combinations thereof) system, process or functionality, or component thereof, that performs or facilitates the processes, features, and/or functions described herein (with or without human interaction or augmentation). A module can include sub-modules. Software components of a module may be stored on a computer readable medium for execution by a processor. Modules may be integral to one or more servers or be loaded and executed by one or more servers. One or more modules may be grouped into an engine or an application.

Those skilled in the art will recognize that the methods and systems of the present disclosure may be implemented in many manners and as such are not to be limited by the foregoing exemplary embodiments and examples. In other words, functional elements being performed by single or multiple components, in various combinations of hardware and software or firmware, and individual functions, may be distributed among software applications at either the client level or server level or both. In this regard, any number of the features of the different embodiments described herein may be combined into single or multiple embodiments, and alternate embodiments having fewer than, or more than, all the features described herein are possible.

Functionality may also be, in whole or in part, distributed among multiple components, in manners now known or to become known. Thus, a myriad of software, hardware, and firmware combinations are possible in achieving the functions, features, interfaces, and preferences described herein. Moreover, the scope of the present disclosure covers conventionally known manners for carrying out the described features and functions and interfaces, as well as those variations and modifications that may be made to the hardware or software or firmware components described herein as would be understood by those skilled in the art now and hereafter.

Furthermore, the embodiments of methods presented and described as flowcharts in this disclosure are provided by way of example to provide a more complete understanding of the technology. The disclosed methods are not limited to the operations and logical flow presented herein. Alternative embodiments are contemplated in which the order of the various operations is altered and in which sub-operations described as being part of a larger operation are performed independently.

While various embodiments have been described for purposes of this disclosure, such embodiments should not be deemed to limit the teaching of this disclosure to those embodiments. Various changes and modifications may be made to the elements and operations described above to obtain a result that remains within the scope of the systems and processes described in this disclosure.

We claim:

1. A device comprising:
a write-protected storage device storing a public key; and
a controller, the controller configured to
receive a command from an operating system;
validate the command using the public key; and
modify access to trace functionality in response to the command.

2. The device of claim 1, wherein the command to modify access to trace functionality comprises one of a command to allow access to trace functionality or a command to disallow access to trace functionality.

3. The device of claim 1, wherein the public key is associated with a private key of a key management system.

4. The device of claim 1, wherein validating the command further includes validating one of a monotonic counter value or nonce value included in the command.

5. The device of claim 1, wherein the trace functionality comprises one or more of access to ftrace, bpf, kprobes, uprobes, USDT tracepoints, LTTng, or perf event system calls.

6. The device of claim 1, wherein modifying access to trace functionality comprises updating one of a register or a subset of bits of the register.

7. The device of claim 1, the controller further configured to:
receive a second command to delegate trace control, the second command signed using a key management system private key and containing a second public key and a digital certificate associated with the second public key;
validate the second command using the public key; and
delegate control of trace functionality to the second public key for a fixed duration, the fixed duration determined based on an expiration time of the digital certificate.

8. A non-transitory computer-readable storage medium for tangibly storing computer program instructions capable of being executed by a computer processor, the computer program instructions defining steps of:
receiving, by a trusted execution environment, a command to delegate trace control, the command signed using a key management system private key and containing a second public key and a digital certificate associated with the second public key;
validating, by the trusted execution environment, the command using a public key stored in a write-protected storage area;
delegating, by the trusted execution environment, control of trace functionality to the second public key for a fixed duration, the fixed duration determined based on an expiration time of the digital certificate; and
reverting, by the trusted execution environment, control of trace functionality to the public key stored in the write-protected storage area upon expiration of the fixed duration.

9. The non-transitory computer-readable storage medium of claim 8, wherein delegating control of trace functionality comprises: storing the second public key in a temporary storage area of the trusted execution environment; and using the second public key to validate commands to modify access to trace functionality during the fixed duration.

10. The non-transitory computer-readable storage medium of claim 9, wherein reverting control of trace functionality comprises: removing the second public key from the temporary storage area; and resetting registers used to control access to trace functionality to a default state.

11. The non-transitory computer-readable storage medium of claim 8, further comprising: receiving, during the fixed duration, a trace control command signed using a private key corresponding to the second public key; validating the trace control command using the second public key; and modifying access to trace functionality based on the trace control command.

12. The non-transitory computer-readable storage medium of claim 11, wherein modifying access to trace functionality comprises updating one or more registers accessible by an operating system, wherein the operating system is configured to allow or disallow access to trace functionality based on contents of the one or more registers.

13. The non-transitory computer-readable storage medium of claim 8, wherein the trace functionality comprises one or more of access to ftrace, bpf, kprobes, uprobes, USDT tracepoints, LTTng, or perf event system calls.

14. The non-transitory computer-readable storage medium of claim 8, the steps further comprising: storing a log of trace control operations performed during the fixed duration; and transmitting the log to a key management system upon expiration of the fixed duration.

15. A method comprising:
receiving, by an operating system, a trace request from a user;
accessing, by the operating system, a register file to determine whether trace functionality is allowed;
if the register file indicates trace functionality is allowed, determining user permissions associated with the trace request;
if the user permissions allow access to the trace functionality, performing the trace functionality; and
if the user permissions do not allow access to the trace functionality, denying the trace request; and if the register file indicates trace functionality is not allowed: denying the trace request.

16. The method of claim 15, wherein the register file comprises a single register with multiple bits, each bit corresponding to a specific trace functionality.

17. The method of claim 15, wherein the register file comprises multiple registers, each register corresponding to a specific trace functionality and containing additional access control information.

18. The method of claim 15, wherein determining user permissions comprises: identifying a user or group associated with the trace request; and comparing the user or group with a list of authorized users or groups stored in the register file.

19. The method of claim 15, wherein performing the trace functionality comprises: determining a logging level for the trace functionality based on information stored in the register file; and executing the trace functionality according to the logging level.

20. The method of claim 15, further comprising: receiving, by a trusted execution environment, a command to modify access to trace functionality; validating the command using a public key stored in a write-protected storage area of the trusted execution environment; and updating the register file based on the command in response to validating the command.
